(19) United States
(12) Patent Application Publication
(10) Pub. No.: US 2009/0017742 A1
(43) Pub. Date: Jan. 15, 2009

(54) Ionized-re-circulating air-aircraft

(76) Inventor: John Anthony Diaks, Bonney Lake, WA (US)

Correspondence Address: JOHN ANTHONY DIAKS, 10801 176 AVENUE EAST, BONNEY LAKE, WA, 98391, US

(21) Appl. No.: 11/648,877

(22) Filed: Jan. 3, 2007

(51) Int. Cl. B64D 13/00

(52) U.S. Cl. 454/76

(57) ABSTRACT

The system and method of the presented concept is to provide clean and healthy, recirculated air to the flying public, while still maintaining the minimum pneumatic air drawn from the engines, which in turn help minimize fuel burn and provides for fuel economy.

This application claims the benefit of a U.S. Provisional application No. US60/750,296, filed on Dec. 15, 2005.

### BACKGROUND OF CONCEPT AND REFERENCE MATERIAL

In retrospect, the following has been my personal experience with the quality of breathing air aboard airplanes, especially on the longer flights and in particular, mostly aboard heritage Boeing airplanes.

On the earlier model Boeing airplanes (707, 727, 737 & 747), air quality seemed not to be a problem. My long experience within the aviation industry and in particular the airlines, very seldom did one hear of complaints about the quality of air during a flight or that it caused people to become sick. Occasionally, exhaust fumes would enter into the cabin while the airplane was still on the ground, or hydraulic fluid somehow leaked onto and into a pneumatic duct. These odors would and could be dissipated through the normal ventilating system and by keeping the pneumatic ducts pressurized and allowing heat to burn off the contaminants prior to flight, thus not contaminating in-flight air quality.

On later model Boeing airplanes (747-400, 757, 767 &777), Boeing and possibly Airbus and other airplane manufactures, that because of the high cost of fuel and in an effort to increase fuel economy, concluded that by reducing the vast amounts of pneumatic air taken from the engines and used for cabin air conditioning and pressurization purposes, substantial fuel savings could be achieved by recycling aircraft cabin air,

To supplement this reduction in engine supplied pneumatic air, it was concluded to re-use (by recirculating) a majority of the air expelled from the cabin, over and over again. This expelled cabin air, is air that has been fouled and contaminated by passenger use and exhausted from the main cabin and dumped into the lower cargo compartments, where a recirculating fan draws this expelled cabin air from a collector shroud and cargo compartment.

Cockpit crew do not receive any recirculated air to breath. They are on their own independent and separate air supply.

### BRIEF DESCRIPTION OF DRAWINGS

FIG. 1. Shows a typical configuration (configurations can vary between airplane models, but all are basically similar), of an air conditioning—main air distribution center. The drawing show the optional location, either separately or in-tandem of the ionizing and ultraviolet units.

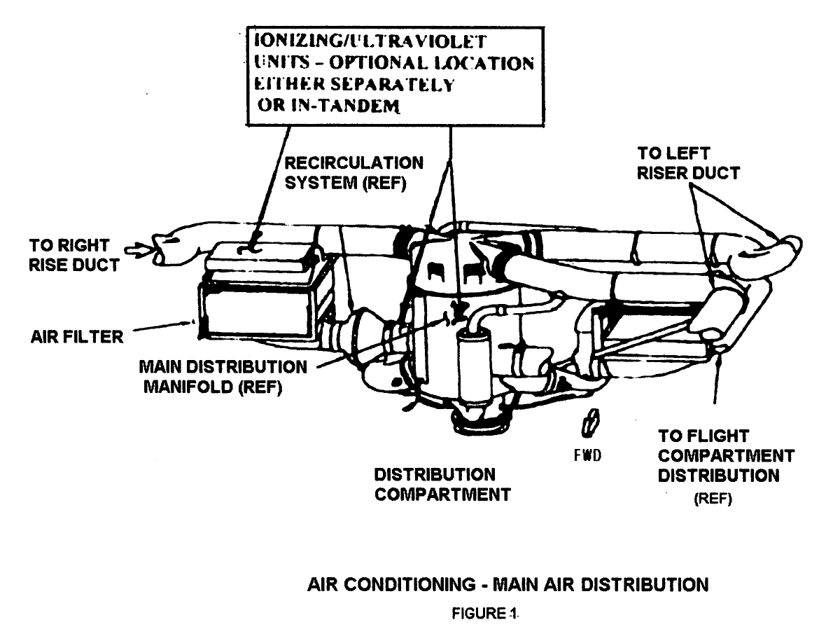

FIG. 2. Shows a typical air conditioning—passenger cabin conditioned air distribution. Air from the main air distribution center (FIG. 1) flows up through riser ducts and out through overhead distribution ducts and sidewall diffuser outlets into the cabin and then exiting the cabin through floor grills.

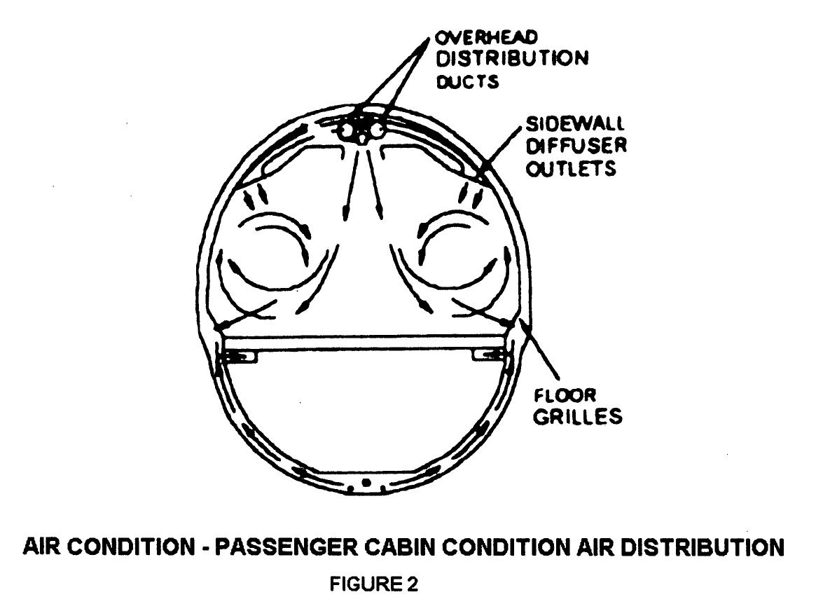

FIG. 3. Shows the air conditioning—recirculating system and a schematic for recirculated air. Also shown are optional locations for the ionizing and ultraviolet lamp units, installed either in tandem or separately.

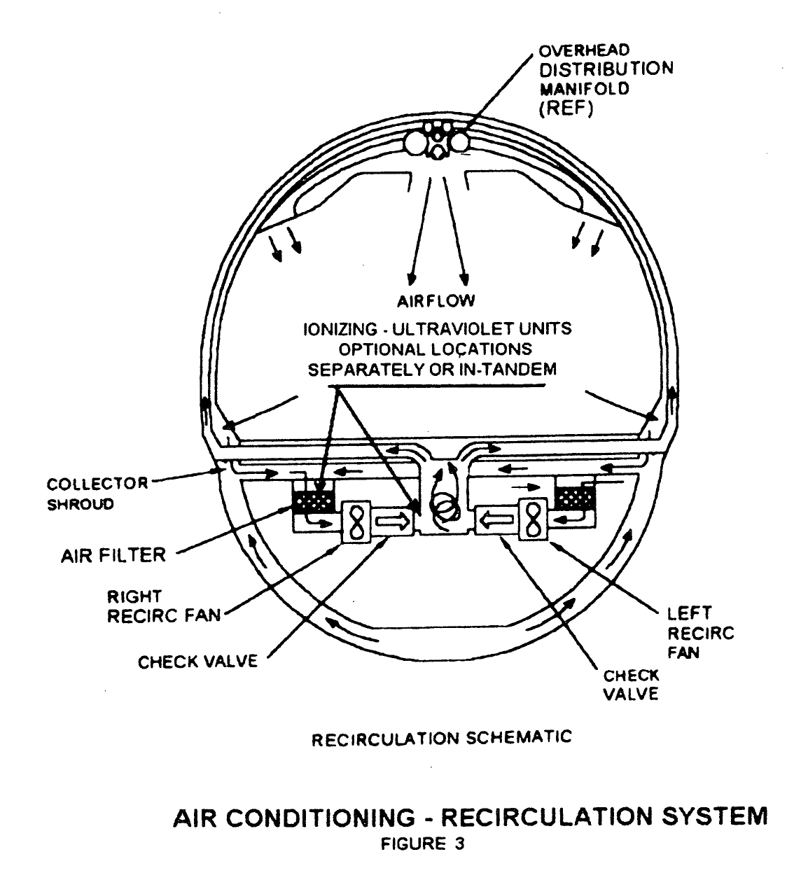

FIG. 4. Shows (the forward cargo compartment looking aft), a typical air conditioning—recirculation system—recirculation air filter location.

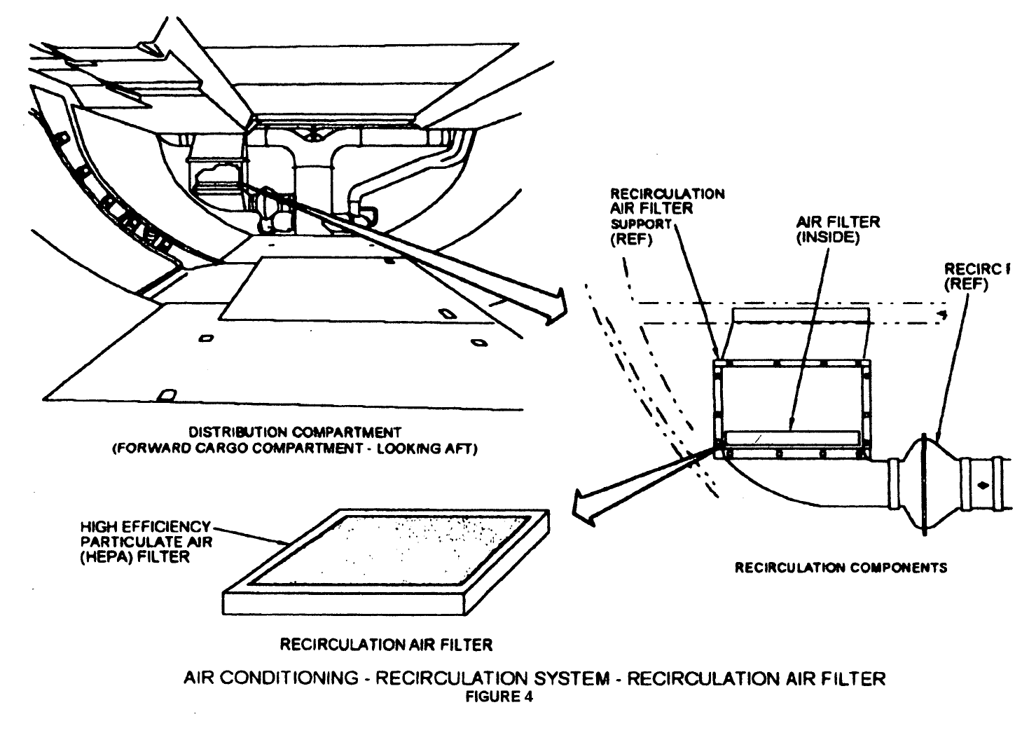

In my opinion, the answer is obvious. Boeing and other airplane manufactures, design and engineering departments, whether by government regulation or not, did not/does not want the flight crews to have any problems from breathing the same potentially contaminated air that passengers could be breathing.

Hyperlink: “http://www-
jetair.aero/Resources.resources.html
boeing.com/commercial/cabinair
aviation-health.com/news/brouse.php?action
show news&category=&id=23topicid=24451
aviationtoday.comsia/20030601 h.html
apois.org/balouetSymptomsoflirritationandToxicityinAirCrew.html.
aerias.org/kview.asp?DocId=134spaceid=4&subid=34-infectious
californialung.orgspotlight/02fw_air_quality.html
house.gov/transportation/aviation/06-05-03/06-05-03memp.html
flyana.com/ful.html.—Air Travel Health News—Diana Fairechild (various hyperlinks within her newsletters).
The Airplane Cabin Environment by Elwood H. Hunt & David R. Space. “http://www.boeing.com/commercial/cabinair/”

Some excerpted documentation for the claim for healthier clean air during flight is herewith included. Along with and included in the excerpted documentatrion are hyperlinks, for additional information for what is seen as an airline industry wide problem.

From Diana Fairechild's hyperlind:” Air Travel Health News, “Airline pilots get ten times more oxygen that passengers get. Insufficient oxygen can cause many symptoms including impaired visual acuity. Of course we all want our pilots to see as well as they possibly can—especially for landings. (As a matter of fact, some airlines require their pilots to inhale oxygen prior to landing so that they are as alert as possible to this crucial phase of the flight.

If the air quality on your flight is bad, request your flight attendant to ask the pilot to provide passengers with the same air quality he's breathing in the cockpit. Speak to your flight attendant about the air quality if: You are having difficulty concentrating on tasks such as reading or business work.

Your lungs ache.

Your skin feels clammy.

You feel nauseated (and there is no turbulence).

You have a headache.

### Ask for Better Air

“Gently, kindly, ask your flight attendant (remember she/he is breathing the same air you are): “When you have time, please ask the flight deck for less recirculated and more fresh air because I'm having trouble breathing. Wait 15 minutes. You'll know if an air pack has been activated. You'll find it easier to breath. “http://www.flyana.com/full.html.

You'll hear a louder woosh from the plane's air-conditioning system.”

### Oxygen Bottle

“There are about 25 portable on every 747. Sipping from a portable oxygen bottle en route helps me feel markedly better both en route and after landing.”

### Sars, TB

“The latest information transmission of tuberculosis on jets says that only those passengers seated “near” the contagious individual are at risk! Hmm, It seems to me it also depends upon where the contagious passenger is seated in relation to the aircraft's air vents and outflow vents, the amount of air being pumped into the cabin, the duration of the flight, the departure location which determines humidity in the cabin for the first few hour, the passenger load, the number of times the contagious individual coughs, if she/he coughs on the way to the lavatory, if you're the next one in that lavatory . . . . What would you do if someone next to you or behind you God forbid, had a hacking cough? I'd find another seat. If I couldn't find another seat, I'd tell the flight attendant (politely, kindly, remember she/he is breathing the same air you are while simultaneously running like a thoroughbred): “I can't sit in that seat any more because I'm afraid that passenger behind me may have TB. “What about flight attendants who catch TB from passengers and then spread it on subsequent flights? This is a being cover up. According to Ms. Diana Fairechilds, article in her “Air Travel Health News,” she has been “contacted by several international flight attendants who have TB.”

1. The purpose of the recirculation system is to supply air for ventilation. The re-use of cabin air for ventilation decreases the use of air from the engine bleed system. The recirculation system collects cabin air to use with pack air in the distribution system. The distributions system supplies air to the passenger compartment. This passenger cabin air, that is to be recirculated, moves across or through these recirculation components.
Collector Shroud
Air Filters (High Efficiency Particulate Air—HEPA and a Pre-filter
Before this expelled cabin air passes across the recirculating fan, it passes through a pre-filter and a high efficiency particulate air filter (HEPA filter). It is my belief that even these filters do not remove major portions of the airborne bacteria, viruses and germs from the air, even though one of the filters is a HEPA filter. By not removing the germs, viruses and bacteria, before allowing this air to re-enter the cabin, it is my belief this is the root cause of many of the passenger ailments and airline complaints. It has been documented that some passengers have been known to pass out, become dizzy, or become sick (cold, running noses, etc,) after being on a flight, for any length of time.
Air, after passing through the pre-filter, HEPA filter and recirculating fan, is then routed to the main distribution manifold, where it is combined with conditioned air from the engine and air cycle machine and finally back into the aircraft cabin.
